(19) United States
(12) Patent Application Publication
(10) Pub. No.: US 2024/0223902 A1
(43) Pub. Date: Jul. 4, 2024

(54) SUPPORT DEVICE THAT PROVIDES BI-DIRECTIONAL ROTATING OF AN ELECTRONIC DEVICE WITH IMAGE CAPTURING COMPONENT FOR SUBJECT IMAGE TRACKING

(71) Applicant: MOTOROLA MOBILITY LLC, WILMINGTON, DE (US)

(72) Inventors: AMIT KUMAR AGRAWAL, BANGALORE (IN); BILL RYAN, LIBERTYVILLE, IL (US); DANIEL M. VACURA, CHICAGO, IL (US); JEFFREY S. VANHOOF, GURNEE, IL (US)

(21) Appl. No.: 18/147,442

(22) Filed: Dec. 28, 2022

(51) Int. Cl. H04N 23/695; G06F 1/16; G06T 7/20

(52) U.S. Cl. CPC H04N 23/695; G06F 1/1632; G06T 7/20

(57) ABSTRACT

A support device, an electronic system of an electronic device on the support device, and a method provide subject tracking up to 360°. A movable subject is identified within an image stream received from an image capturing device (ICD) of an electronic device that is positioned on a docking structure of a support device. The docking structure is received for rotation on a base of the support device. In response to determining that the movable subject is moving in either a first direction or an opposite second direction within the image stream. The electronic device transmits a rotation command indicating the first or the second direction to prompt the support device to trigger a rotation actuator of the support device to rotate the docking structure in a corresponding first or second rotation direction, enabling the electronic device to maintain the movable subject within a field of view of the ICD.

### BACKGROUND

### 1. Technical Field

The present disclosure relates generally to docking stations for mobile electronic devices, and more particularly to docking stations for mobile electronic device having a camera that performs subject image tracking.

### 2. Description of the Related Art

Electronic devices such as mobile phones, network servers, desktop workstations, laptops, and tablets are often equipped with a camera that is used to capture images and videos of subjects, including video for podcasts and communication sessions. Outside of physical movement of the device by the user, conventional electronic devices have a limited capability to aim the device's camera to maintain a moving subject being captured within a field of view of the camera. Some conventional electronic devices have a mechanical gimbal to aim the camera. Also, some conventional electronic devices have the capability to simulate aiming the camera by digitally selecting cropped portions of a large digital image. The subject is constrained to move only within the simulated gimbal limits of the camera. The subject is similarly constrained to move only within the total fixed field of view of the camera in order to maintain the subject of the video within the field of view of the camera. To enable the subject to move freely around the electronic device, a camera operator or user has to move the electronic device, which is inconvenient when the user is also the subject. In some instances, the subject of the video conspicuously repositions the device camera, detracting from the content of the video presentation.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts a functional block diagram of an electronic system including an electronic device and a support device that bi-directionally rotates the electronic device, in order to track a subject of a video being captured by a camera of the electronic device, according to one or more embodiments;

FIG. 2 depicts a functional block diagram of an example electronic device that is configured as a communication device to communicate the video with communication networks and other wireless devices, according to one or more embodiments;

FIG. 3A depicts a top view of the electronic system with the electronic device controlling the support device to rotate and track the movable subject within a field of view of an image capturing device by rotating clockwise, according to one or more embodiments;

FIG. 3B depicts a top view of the electronic system with the electronic device controlling the support device to rotate and track the movable subject within a field of view of an image capturing device by rotating counterclockwise, according to one or more embodiments;

FIG. 4A depicts a front view of an example electronic device having a flip form factor in an open position, according to one or more embodiments;

FIG. 4B depicts a back view of an example electronic device having a flip form factor in an open position, according to one or more embodiments;

FIG. 5 depicts a three-dimensional view of the example electronic device having the flip form factor in a partially open position and placed in a tent orientation on an example support device, according to one or more embodiments;

FIG. 6 depicts a three-dimensional view of the example electronic device having the flip form factor while in the partially open position and placed in an L-shaped orientation on an example support device, according to one or more embodiments;

FIG. 7 depicts a three-dimensional view of an example electronic device having an elongate straight shape being placed on a docking structure of the support device having an aft slanted easel support, according to one or more embodiments;

FIGS. 8A-8B (collectively “FIG. 8”) are a flow diagram presenting a method of controlling bidirectional rotation of a support device to allow tracking of a subject moving within a field of view of an image capturing device of an electronic device placed on the support device, according to one or more embodiments; and

FIG. 9 is a flow diagram presenting a method of determining a current rotation rate of the electronic system based on image recognition, according to one or more embodiments.

### DETAILED DESCRIPTION

According to one or more aspects of the present disclosure, a support device, an electronic system including the support device and an electronic device with an image capturing device (ICD) such as an integrated camera, and a method enable “hands free” video recording with up to 360° tracking of a subject in a field of view of the (ICD). The support device includes a base that is positionable on a stationary surface. A rotatable docking structure of the support device is received by the base. A rotation actuator of the support device is configured to rotate the docking structure relative to the base. The support device includes a first controller and a communication component. The controller is communicatively coupled to the rotation actuator and the communication component. The electronic device includes a housing configured for positioning on the docking structure. The electronic device includes an ICD positioned at an exterior of the housing to have a field of view that captures an image stream that can encompass a movable/moving subject. The electronic device includes a communications subsystem configured to transmit rotation commands to the support device. The communication component of the support device is configured to receive the rotation commands from the electronic device. The electronic device includes a second controller communicatively connected to the ICD and the communications subsystem. The second controller identifies the movable subject within the image stream received from the ICD. In response to determining that the movable subject is moving in a first direction, the second controller transmits, via the communications subsystem to the communication component of the support device, a rotation command indicating the first direction. The first controller is prompted to trigger the rotation actuator to rotate in a first rotation direction that corresponds to the first direction, enabling the ICD of the electronic device to maintain the movable subject within the field of view. In response to determining that the movable subject is moving in the second direction, the second controller transmits, via the communications subsystem to the communication component of the support device, a rotation command indicating the second direction. The first controller is prompted to trigger the rotation actuator to rotate in a second rotation direction that corresponds to the second direction, enabling the ICD of the electronic device to maintain the movable subject within the field of view.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

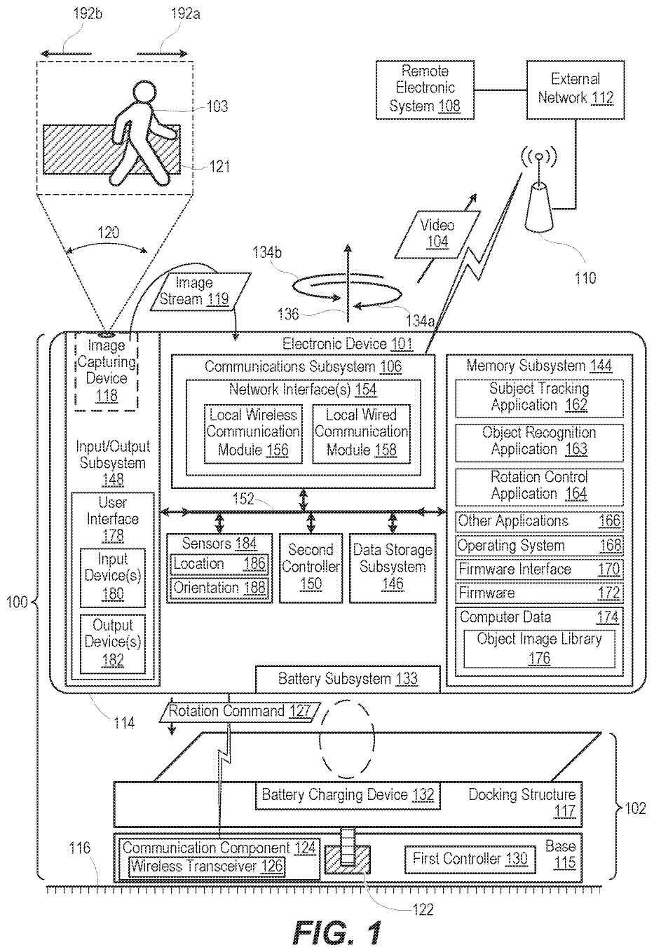

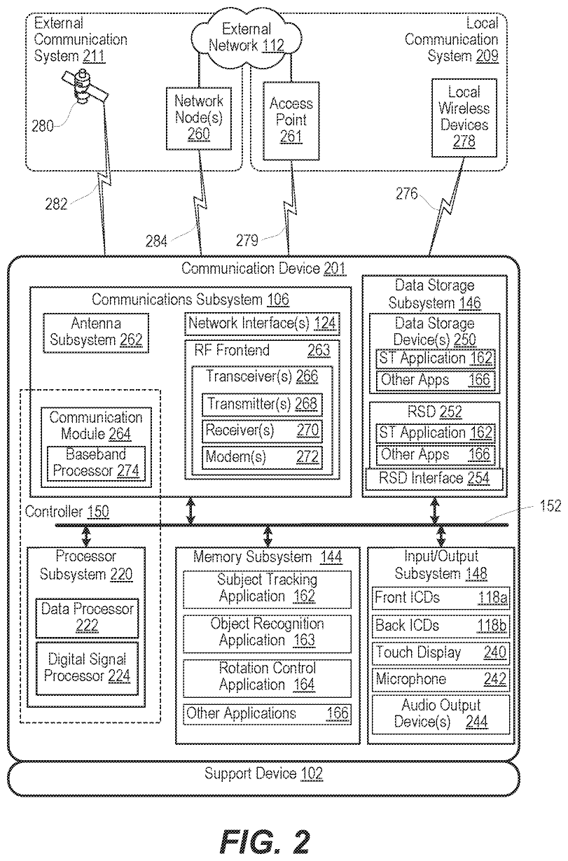

FIG. 1 depicts a functional block diagram of electronic system 100 including electronic device 101 that tracks movable subject 103 by communicating bidirectional rotation commands to support device 102. Electronic device 101 can be one of a host of different types of devices, including but not limited to, an infant monitoring system, a mobile cellular phone, satellite phone, or smart phone, a laptop, a netbook, an ultra-book, a networked smart watch, networked sports/exercise watch, and/or a tablet computing device or similar device. As more completely presented as communication device 201 of FIG. 2, which is described hereafter, electronic device 101 can also be a device supporting wireless communication. In these implementations, electronic device 101 can be utilized as, and also be referred to as, a system, device, subscriber unit, subscriber station, mobile station (MS), mobile, mobile device, remote station, remote terminal, user terminal, terminal, user agent, user device, a Session Initiation Protocol (SIP) phone, a wireless local loop (WLL) station, a personal digital assistant (PDA), computer workstation, a handheld device having wireless connection capability, a computing device, or other processing devices connected to a wireless modem. Most importantly, it is appreciated that the features described herein can be implemented with a display device of various other types of electronic devices that are not necessarily a communication device. The specific presentation or description herein of a mobile communication device in addition to a data processing system as different examples of electronic device 101 are for example only, and not intended to be limiting on the disclosure. In one aspect, electronic device 101 may operate standalone without necessarily communicating with other electronic devices when generating video 104. In another aspect, electronic device 101 may include communications subsystem 106 that communicates video 104 with remote electronic system 108 via network node 110 and external network 112.

Housing 114 of electronic device 101 is configured for positioning on support device 102. Support device 102 includes base 115 that is positionable on underlying stationary surface 116, such as a floor or top surface of a desk or other furniture. Support device 102 includes docking structure 117 rotatably received by base 115. Docking structure 117 positions ICD 118 of electronic device 101, as described further below. ICD 118 is positioned at an exterior of housing 114 to have field of view (FOV) 120 that captures image stream 119 encompassing movable subject 103 and stationary components 121. Support device 102 includes rotation actuator 122 configured to rotate docking structure 117 relative to base 115. Support device 102 includes communication component 124, which may include wireless transceiver 126, configured to detect rotation commands 127 from electronic device 101. First controller 130 is communicatively coupled to rotation actuator 122 and communication component 124. In one or more embodiments, support device 102 includes battery charging device 132 that is one of electrically connected and electromagnetically coupled to electronic device 101 to transfer electrical charge to battery subsystem 133 of electronic device 101.

Referring now to the specific component makeup and the associated functionality of the presented components of electronic device 101, electronic device 101 includes communications subsystem 106, memory subsystem 144, data storage subsystem 146, and input/output subsystem 148 managed by second controller 150. System interlink 152 communicatively connects second controller 150 with communications subsystem 106, memory subsystem 144, data storage subsystem 146, and input/output subsystem 148. Communications subsystem 106 may include one or more network interfaces 154 such as low power local wireless communication module 156 and local wired communication module 158 to communicatively couple to external networks 112.

Memory subsystem 144 includes program code for applications, such as subject tracking application 162, object recognition application 163, rotation control application 164, and other applications 166. Memory subsystem 144 further includes operating system (OS) 168, firmware interface 170, such as basic input/output system (BIOS) or Uniform Extensible Firmware Interface (UEFI), and firmware 172. Memory subsystem 144 stores computer data 174 that is used by object recognition application 163, such as object image library 176 that supports recognizing movable subject 103 and stationary components 121.

In one or more embodiments, input/output subsystem 148 provides user interface device(s) 178 of one or more input devices 180, such as ICD 118, and one or more output devices 182. User interface device(s) devices 178 may enable user interaction with electronic device 101 using inputs and outputs that are one or more of visual, haptic, touch, sound, gesture, etc. In one or more embodiments, electronic device 101 includes movement sensors 184 that are responsive to positioning and movement of electronic device 101, such as location sensor 186 and orientation sensor 188.

According to aspects of the present disclosure, second controller 150 identifies movable subject 103 within image stream 119 received from ICD 118. In response to determining that movable subject 103 is moving in first direction 192a, second controller 150 transmits, via communications subsystem 106 to communication component 124 of support device 102, rotation command 127 indicating first direction 192a to prompt first controller 130 of support device 102 to trigger rotation actuator 122 to rotate in first rotation direction 134a around vertical center of rotation 136 that corresponds to first direction 192a. This rotation enables ICD 118 of electronic device 101 to maintain movable subject 103 within FOV 120. In response to determining that movable subject 103 is moving in second direction 192b, second controller 150 transmits, via communications subsystem 106 to communication component 124 of support device 102, rotation command 127 indicating second direction 192b to prompt first controller 130 to trigger rotation actuator 122 to rotate in second rotation direction 134b around vertical center of rotation 136 that corresponds to second direction 192b. This rotation enables the ICD 118 of electronic device 101 to maintain movable subject 103 within FOV 120.

In one or more embodiments, second controller 150 of electronic device 101 performs image object recognition to identify movable subject 103 within captured image stream 119. Second controller 150 performs image object recognition to distinguish one or more stationary components 121 contained in FOV 120. Second controller 150 determines a current rotation rate of electronic device 101 based on spatial movement of one or more stationary components 121 in FOV 120. Second controller 150 identifies a target rotation rate of electronic device 101 to maintain movable subject 103 within FOV 120 based on at least one of: (i) spatial offset of movable subject 103 from a center of FOV 120; and (ii) a rate and direction of spatial movement of movable subject 103 within FOV 120. Second controller 150, via rotation commands 127 to first controller 130, adjusts a rotation rate and rotation direction of rotation actuator 122 in relation to a difference between the target rotation rate and direction and the current rotation rate and direction.

In one or more embodiments, electronic device 101 further includes movement sensor 184 that is communicatively coupled to second controller 150 and configured to detect a movement of electronic device 101 related to a rotation rate. Second controller 150 identifies a target rotation rate of electronic device 101 to maintain movable subject 103 within FOV 120. Second controller 150 receives, from movement sensor 184, a current rotation rate of the electronic device 101. Second controller 150, via rotation commands 127 to first controller 130, adjusts a rotation rate of rotation actuator 122 in relation to a difference between the target rotation rate and the current rotation rate.

FIG. 2 depicts communication device 201 configured to communicate with communication networks and other wireless devices and communicate a video generated using automatic subject tracking. Communication device 201 is an implementation of electronic device 101 (FIG. 1). Communication device 201 includes communications subsystem 106, memory subsystem 144, data storage subsystem 146, input/output subsystem 148, and second controller 150, as previously described with regard to electronic device 101 (FIG. 1) but having additional functionality, such as additional communication capabilities for controlling support device 102.

Second controller 150 includes processor subsystem 220, which executes program code to provide operating functionality of communication device 201. Second controller 150 manages, and in some instances directly controls, the various functions and/or operations of communication device 201. These functions and/or operations include, but are not limited to including, application data processing, communication with second communication devices, navigation tasks, image processing, and signal processing. In one or more alternate embodiments, communication device 201 may use hardware component equivalents for application data processing and signal processing. For example, communication device 201 may use special purpose hardware, dedicated processors, general purpose computers, microprocessor-based computers, micro-controllers, optical computers, analog computers, dedicated processors and/or dedicated hard-wired logic.

The software and/or firmware modules executed by processor subsystem 220 have varying functionality when their corresponding program code is executed by data processor(s) 222 or secondary processing devices within communication device 201 such as digital signal processor 224. Processor subsystem 220 can include other processors that are communicatively coupled internally or externally to data processor 222. Data processor 222 is communicatively coupled, via system interlink 152, to data storage subsystem 146 and memory subsystem 144. System interlink 152 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (system interlink 152) are illustrated in FIGS. 1-2, it is to be understood that more, fewer, or different interconnections may be present in other embodiments.

Processor subsystem 220 of second controller 150 can execute program code of subject tracking application 162, object recognition application 163, rotation control application 164 to configure communication device 201 to perform specific functions for controlling vibration to perform subject tracking. Processor subsystem 220 receives data from certain components of input/output subsystem 148 and presents data on certain components of input/output subsystem 148. In an example, input/output subsystem 148 includes front and back ICDs 118a-118b, touch display 240, microphone 242, and audio output device(s) 244.

Data storage subsystem 146 of communication device 201 includes data storage device(s) 250. Second controller 150 is communicatively connected, via system interlink 152, to data storage device(s) 250. Data storage subsystem 146 provides applications, program code, and stored data on nonvolatile storage that is accessible by second controller 150. For example, data storage subsystem 146 can provide a selection of applications and computer data, such as subject tracking application 162 and other application(s) 166. These applications can be loaded into memory subsystem 144 for execution by second controller 150. In one or more embodiments, data storage device(s) 250 can include hard disk drives (HDDs), optical disk drives, and/or solid-state drives (SSDs), etc. Data storage subsystem 146 of communication device 201 can include removable storage device(s) (RSD(s)) 252, which is received in RSD interface 254. Second controller 150 is communicatively connected to RSD 252, via system interlink 152 and RSD interface 254. In one or more embodiments, RSD 252 is a non-transitory computer program product or computer readable storage device. Second controller 150 can access data storage device(s) 250 or RSD 252 to provision communication device 201 with program code, such as code for subject tracking application 162 and other application(s) 166.

Communication device 201 further includes communications subsystem 106 for communicating, using a cellular connection, with network node(s) 260 of external communication system 211 and for communicating, using a wireless connection, with wireless access point 261 of local communication system 209. Communications subsystem 106 includes antenna subsystem 262. Communications subsystem 106 includes radio frequency (RF) front end 263 and communication module 264. RF front end 263 includes transceiver(s) 266, which includes transmitter(s) 268 and receiver(s) 270. RF front end 263 further includes modem(s) 272. Communication module 264 of communications subsystem 106 includes baseband processor 274 that communicates with second controller 150 and RF front end 263. Baseband processor 274 operates in a baseband frequency range to encode data for transmission and decode received data, according to a communication protocol. Modem(s) 272 modulates baseband encoded data from communication module 264 onto a carrier signal to provide a transmit signal that is amplified by transmitter(s) 268. Modem(s) 272 demodulates each signal received from external communication system 211 using antenna subsystem 262. The received signal is amplified and filtered by receiver(s) 270, which demodulates received encoded data from a received carrier signal.

In one or more embodiments, second controller 150, via communications subsystem 106, performs multiple types of cellular OTA or wireless communication with local communication system 209. Communications subsystem 106 can communicate via an over-the-air (OTA) connection 276 with local wireless devices 278. In an example, OTA connection 276 is a peer-to-peer connection, Bluetooth connection, or other personal access network (PAN) connection. In one or more embodiments, communications subsystem 106 communicates with one or more locally networked devices via a wireless local area network (WLAN) link 279 supported by access point 261. In one or more embodiments, access point 261 supports communication using one or more IEEE 802.11 WLAN protocols. Access point 261 is connected to external networks 112 via a cellular connection. In one or more embodiments, communications subsystem 106 communicates with GPS satellites 280 via downlink channel 282 to obtain geospatial location information. Communications subsystem 106 can communicate via an over-the-air (OTA) cellular connection 284 with network node(s) 260.

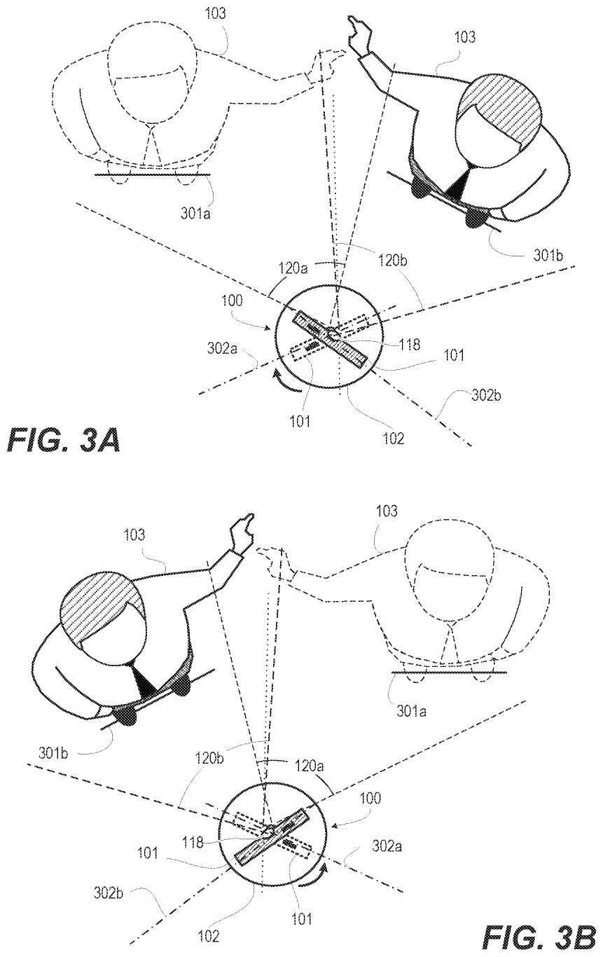

FIG. 3A depicts a top view of electronic system of electronic device 101 on support device 102 rotating clockwise as viewed from above to track movable subject 103 within FOV 120a of ICD 118. In particular, at a first time, movable subject 103 is at first position 301a with electronic device 101 positioned on support device 102 at a stationary location positioned at first rotation angle 302a. At a second time, movable subject 103 is at second position 301b that is to the right of first position 301a as depicted from a vantage point of electronic device 101 that is at second rotation angle 302b. FOV 120 of electronic device 101 at the first time rotates clockwise as viewed from above to FOV 120′ at the second time as support device 102 rotates in a first mode from first rotation angle 302a to second rotation angle 302b.

FIG. 3B depicts a top view of electronic system of electronic device 101 on support device 102 rotating counterclockwise as viewed from above to track movable subject 103 within FOV 120a of ICD 118. In particular, at a first time, movable subject 103 is at first position 301a with electronic device 101 positioned on support device 102 at a stationary location positioned at first rotation angle 302a. At a second time, movable subject 103 is at second position 301b that is to the left of first position 301a as depicted from a vantage point of electronic device 101 that is at second rotation angle 302b. FOV 120 of electronic device 101 at the first time rotates counterclockwise as viewed from above to FOV 120′ at the second time as support device 102 rotates in a first mode from first rotation angle 302a to second rotation angle 302b.

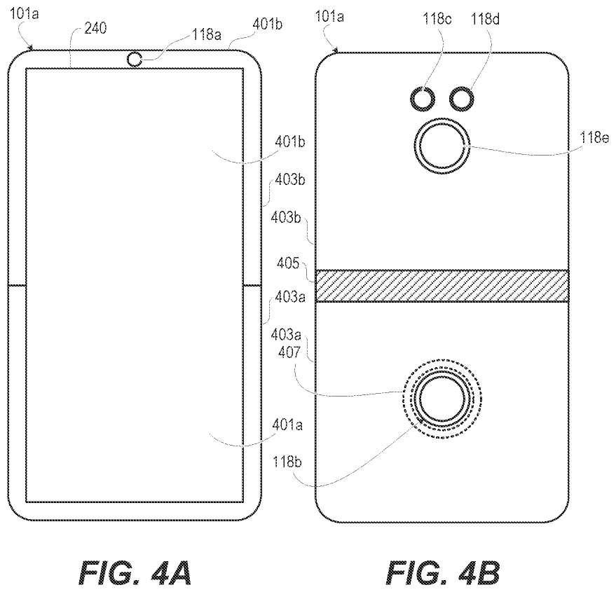

FIG. 4A depicts a front view of electronic device 101a having a flip form factor and in an open position to present bottom and top portions 401a-401b of touch display 240 respectively supported by first and second housings 403a-403b of housing 114. In one or more embodiments, touch display 240 is a flexible display having an excess portion that rolls or scrolls at one or both ends to lay flat on first and second housings 403a-403b. Front ICD 118a is exposed adjacent to top portion 401b of touch display 240 on second housing 403b. FIG. 4B depicts a back view of electronic device 101a in an open position. Hinge 405 couples first housing 403a to second housing 403b. First housing 403a is pivotable about hinge 405 relative to second housing 403b between a folded closed position and an unfolded open position. In one or more embodiments, back ICD 118b is exposed on a back side of first housing 403a. Third, fourth, and fifth ICDs 118c. 118d, and 118e are exposed on a backside of second housing 403b. In an example, third, fourth, and fifth ICDs 118c. 118d, and 118e may represent panoramic, macro, and telephoto cameras. In one or more embodiments, first housing 403a includes convex portion 407 exposed toward the back side.

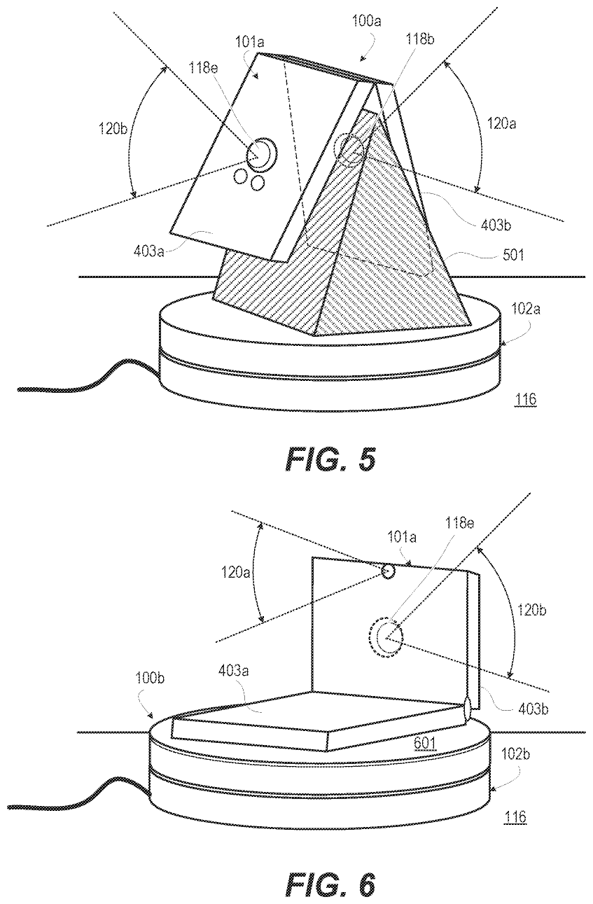

FIG. 5 depicts a three-dimensional view of example electronic system 100a including electronic device 101a having the flip form factor in a partially open position. Electronic device 101a is placed in a tent orientation, which looks like a capital Greek letter lambda “A”, on support device 102a. In particular, support device 102a presents corresponding tent or A-frame support structure 501 to support partially opened electronic device 101. In the tent orientation, back ICD 118b exposed on a back side of first housing 403a is positioned to have a generally horizontal FOV 120a toward a first lateral side. Back ICD 118e exposed on a back side of second housing 403b is positioned to have a generally horizontal FOV 120b toward an opposite second lateral side. Electronic device 101a rotates while in the tent position in response to bidirectional control commands to support device 102a.

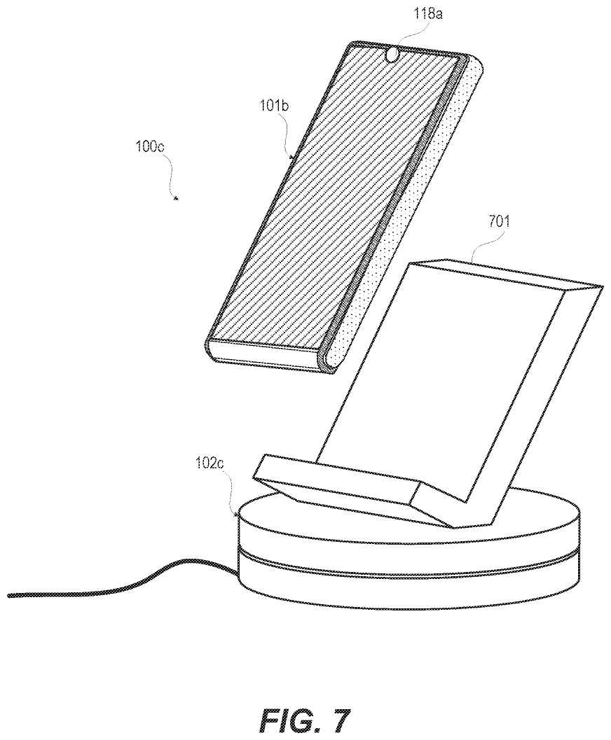

FIG. 6 depicts a three-dimensional view of example electronic system 100b including electronic device 101a having the flip form factor in the partially open position and placed in an orientation that looks like capital letter “L” on support device 102b. In particular, the “L-shaped” orientation includes having first housing 403a placed or seated horizontally on top support surface 601 of support device 102b with second housing 403b unfolded to extend upwards/vertically in approximately a perpendicular position from the first housing 403a. In the L-shaped orientation, front ICD 118a exposed on a front side of second housing 403a is positioned to have a generally horizontal FOV 120a toward a first lateral side. Back ICD 118e exposed on a back side of second housing 403b is positioned to have a generally horizontal FOV 120b toward an opposite second lateral side. Electronic device 101a is rotated in the L-shaped orientation in response to bidirectional control commands to support device 102b.

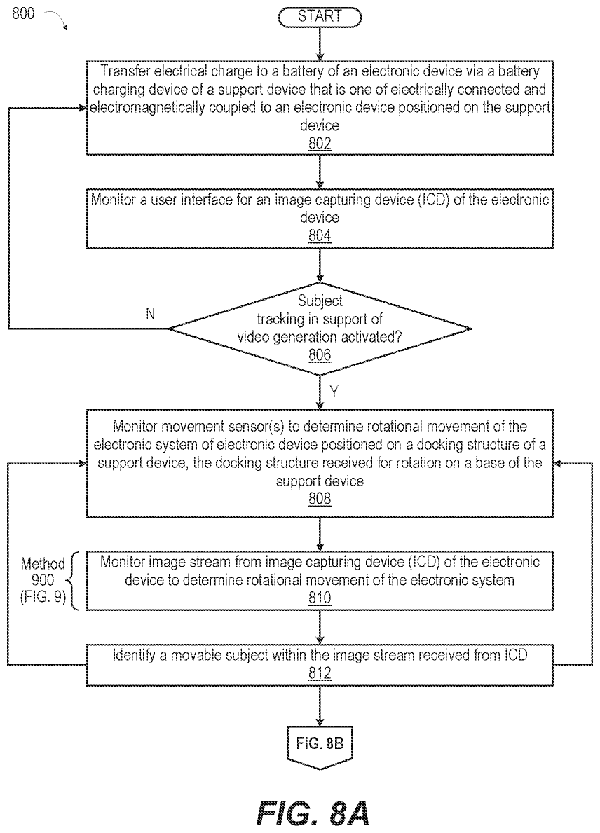

FIG. 7 depicts a three-dimensional view of electronic system 100c including example electronic device 101b designed with an elongate straight shape being placed on support device 102c which incorporates or provides a docking structure. In particular, electronic device 101b is placed on support device 102c configured to include docking structure 117 having aft slanted easel support 701. Electronic device 101b may be one of a “candy bar” form factor, a folding flip form factor while in an open position, or a telescoping form factor.

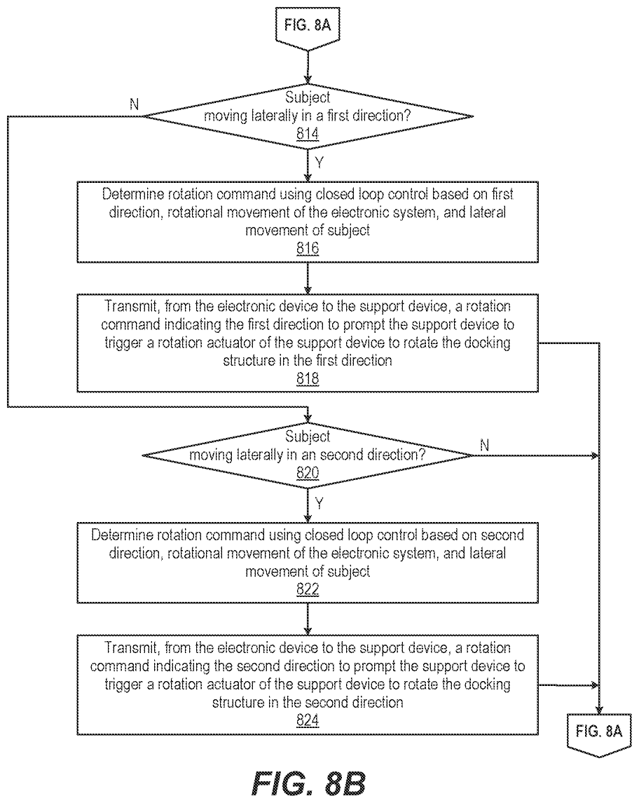

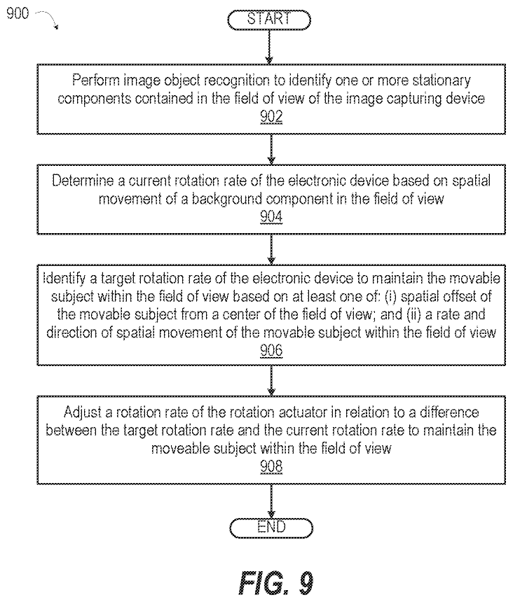

FIGS. 8A-8B (collectively “FIG. 8”) are a flow diagram presenting method 800 of controlling bidirectional rotation of a support device that supports an electronic device to allow tracking of a subject moving within a field of view of an image capturing device (ICD) of the electronic device. FIG. 9 is a flow diagram presenting method 900 of determining a current rotation rate using image recognition as an alternative to a motion sensor. In an example, method 900 may enable calibration of rotation performance for different support surfaces that may require different vibration settings to achieve rotation. In another example, method 900 may provide rates of rotation for closed loop control of rate of rotation to improve the video. Method 900 (FIG. 9) adds additional functionality to method 800 (FIG. 8). The descriptions of method 800 (FIGS. 8A-8B) and method 900 (FIG. 9) are provided with general reference to the specific components illustrated within the preceding FIGS. 1-2, 3A-3B, 4A-4B, and 5-7. Specific components referenced in method 800 (FIG. 8) and method 900 (FIG. 9) may be identical or similar to components of the same name used in describing preceding FIGS. 1-2, 3A-3B, 4A-4B, and 5-7. In one or more embodiments, first and second controllers 130 and 150 (FIG. 1) provide functionality of method 800 (FIGS. 8A-8B) and method 900 (FIG. 9).

With reference to FIG. 8A, in one or more embodiments, method 800 further includes transferring electrical charge to a battery of an electronic device via a battery charging device of a support device that is one of electrically connected and electromagnetically coupled to an electronic device positioned on the support device (block 802). Method 800 includes monitoring a user interface for an image capturing device (ICD) of the electronic device (block 804). Method 800 includes determining whether subject tracking in support of video generation is activated (decision block 806). In response to determining that subject tracking in support of video generation is not activated, method 800 returns to block 802. In response to determining that subject tracking in support of video generation is activated, in one or more embodiments, method 800 includes monitoring movement sensor(s) to determine rotational movement of the electronic system of electronic device positioned on a docking structure of a support device, the docking structure received for rotation on a base of the support device (block 808). Alternatively, the electronic system does not include movement sensor(s). In one or more embodiments, method 800 includes monitoring an image stream from the ICD) of the electronic device to determine rotational movement of the electronic system (block 810). An implementation of block 810 is described below in method 900 (FIG. 9). Method 800 includes identifying a movable subject within an image stream received from an ICD (block 812). Then method 800 proceeds to block 814 of FIG. 8B.

With reference to FIG. 8B, method 800 includes determining whether the movable/moving subject is moving laterally in a first direction within the field of view of the ICD (decision block 814). In response to determining that the movable subject is moving in the first direction, in one or more embodiments, method 800 includes determining rotation command using closed loop control based on first direction, rotational movement of the electronic system, and lateral movement of subject (block 816). Alternatively, electronic device performs subject tracking without closed loop control with rotation speed information. Method 800 includes transmitting, from the electronic device to the support device, a rotation command indicating the first direction and rotation amount or angle to prompt the support device to trigger a rotation actuator of the support device to rotate the docking structure in the first direction by the specific rotation angle, enabling the ICD of the electronic device to maintain the movable subject within the field of view (block 818). Then method 800 returns to block 802 (FIG. 8A). In response to determining that the movable subject is not moving in the first direction in decision block 814, method 800 includes determining whether the movable subject is moving in a second direction that is opposite to the first direction (decision block 820). In response to determining that the movable subject is moving in the second direction, method 800 includes determining rotation command using closed loop control based on second direction, rotational movement of the electronic system, and lateral movement of subject (block 822). Method 800 includes transmitting, from the electronic device to the support device, a rotation command indicating the second direction and second rotation amount or angle to prompt the support device to trigger the rotation actuator to rotate in the second rotation direction by the specific rotation amount, enabling the ICD of the electronic device to maintain the movable subject within the field of view (block 824). Then method 800 returns to block 802 (FIG. 8A). In response to determining that the movable subject is not moving in the second direction, method 800 returns to block 802 (FIG. 8A).

With reference to FIG. 9, method 900 includes performing image object recognition to identify one or more stationary components contained in the field of view of the ICD (block 902). Method 900 includes determining a current rotation rate of the electronic device based on spatial movement of a background component in the field of view (block 904). Method 900 includes identifying a target rotation rate of the electronic device to maintain the movable subject within the field of view based on at least one of: (i) spatial offset of the movable subject from a center of the field of view; and (ii) a rate and direction of spatial movement of the movable subject within the field of view (block 906). Method 900 includes adjusting a rotation rate of the rotation actuator in relation to a difference between the target rotation rate and the current rotation rate to maintain the moveable subject within the field of view (block 908). Then method 900 ends.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation is not limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising.” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. A support device comprising:
a base positionable on an underlying surface;
a docking structure rotatably received by the base and that positions an image capturing device of an electronic device to have a field of view;
a rotation actuator configured to rotate the docking structure relative to the base;
a communication component configured to detect rotation commands from the electronic device; and
a controller communicatively coupled to the rotation actuator and the communication component, and which:
receives, via the communication component, a rotation command from the electronic device;
in response to determining that the rotation command indicates rotation in a first direction, triggers the rotation actuator to rotate a first rotation direction that corresponds to the first direction, enabling the image capturing device of the electronic device to maintain a movable subject identified within the field of view as the movable subject moves in the first direction; and
in response to determining that the rotation command indicates rotation in a second direction, opposite to the first direction, triggers the rotation actuator to rotate in the second rotation direction that corresponds to the second direction, enabling the image capturing device of the electronic device to maintain the movable subject within the field of view as the movable subject moves in the second direction.

2. The support device of claim 1, further comprising a battery charging device that is one of electrically connected and electromagnetically coupled to the electronic device to transfer electrical charge to a battery of the electronic device.

3. The support device of claim 1, wherein the communication component comprises a wireless receiver.

4. The support device of claim 1, wherein the electronic device has a candy bar form factor, and the docking structure comprises an aft slanted easel support configured to receive the electronic device having the candy bar form factor.

5. The support device of claim 1, wherein the electronic device has a folding form factor, and the docking structure comprises an A-frame shape configured to receive the electronic device having the folding form factor and positioned in a partially unfolded tent shape.

6. The support device of claim 1, wherein the electronic device has a folding form factor, and the docking structure comprises a horizontal surface to receive the electronic device having the folding form factor and positioned in a partially unfolded L-shape.

7. An electronic system comprising:
a support device comprising:
a base positionable on a stationary surface;
a docking structure rotatably received by the base;
a rotation actuator configured to rotate the docking structure relative to the base;
a communication component; and
a first controller communicatively coupled to the rotation actuator and the communication component; and
an electronic device comprising:
a housing configured for positioning on the docking structure;
an image capturing device positioned at an exterior of the housing to have a field of view that captures an image stream that can encompass a movable subject;
a communications subsystem configured to transmit rotation commands to the support device, the communication component configured to receive the rotation commands from the electronic device; and
a second controller communicatively connected to the image capturing device and the communications subsystem, and which:
identifies the movable subject within the image stream received from the image capturing device;
in response to determining that the movable subject is moving in a first direction, transmits, via the communications subsystem to the communication component of the support device, a rotation command indicating the first direction to prompt the first controller to trigger the rotation actuator to rotate in a first rotation direction that corresponds to the first direction, enabling the image capturing device of the electronic device to maintain the movable subject within the field of view; and
in response to determining that the movable subject is moving in the second direction, transmits, via the communications subsystem to the communication component of the support device, a rotation command indicating the second direction to prompt the first controller to trigger the rotation actuator to rotate in a second rotation direction that corresponds to the second direction, enabling the image capturing device of the electronic device to maintain the movable subject within the field of view.

8. The electronic system of claim 7, wherein the second controller of the electronic device:
performs image object recognition to identify the movable subject;
performs image object recognition to distinguish one or more stationary components contained in the field of view;
determines a current rotation rate of the electronic device based on spatial movement of the one or more stationary components in the field of view;
identifies a target rotation rate of the electronic device to maintain the movable subject within the field of view based on at least one of: (i) spatial offset of the movable subject from a center of the field of view; and (ii) a rate and direction of spatial movement of the movable subject within the field of view; and
adjusts a rotation rate of the rotation actuator in relation to a difference between the target rotation rate and the current rotation rate.

9. The electronic system of claim 7, wherein the electronic device further comprises a movement sensor communicatively coupled to the second controller and configured to detect a movement of the electronic device related to rotation rate, wherein the second controller:
identifies a target rotation rate of the electronic device to maintain the movable subject within the field of view;
receives, from the movement sensor, a current rotation rate of the electronic device; and
adjusts a rotation rate of the rotation actuator in relation to a difference between the target rotation rate and the current rotation rate.

10. The electronic system of claim 7, further comprising a battery charging device that is one of electrically connected and electromagnetically coupled to the electronic device to transfer electrical charge to a battery of the electronic device.

11. The electronic system of claim 7, wherein the docking structure comprises an aft slanted easel support configured to receive the electronic device having a candy bar form factor.

12. The electronic system of claim 7, wherein the docking structure comprises an A-frame shape configured to receive the electronic device having a folding form factor that is positioned in a partially unfolded tent shape.

13. The electronic system of claim 7, wherein the docking structure comprises a horizontal surface to receive the electronic device having a folding form factor that is positioned in a partially unfolded L-shape.

14. A method comprising:
identifying a movable subject within an image stream received from an image capturing device of an electronic device that is positioned on a docking structure of a support device, the docking structure received for rotation on a base of the support device;
in response to determining that the movable subject is moving in a first direction, transmitting, from the electronic device to the support device, a rotation command indicating the first direction to prompt the support device to trigger a rotation actuator of the support device to rotate the docking structure in a first rotation direction that corresponds to the first direction, enabling the image capturing device of the electronic device to maintain the movable subject within a field of view of the image capturing device; and
in response to determining that the movable subject is moving in a second direction opposite to the first direction, transmitting, from the electronic device to the support device, a rotation command indicating the second direction to prompt the support device to trigger the rotation actuator to rotate in a second rotation direction that corresponds to the second direction, enabling the image capturing device of the electronic device to maintain the movable subject within the field of view.

15. The method of claim 14, further comprising:
performing image object recognition to identify the movable subject;
performing image object recognition to distinguish one or more stationary components contained in the field of view;
determining a current rotation rate of the electronic device based on spatial movement of the one or more stationary components in the field of view;
identifying a target rotation rate of the electronic device to maintain the movable subject within the field of view based on at least one of: (i) spatial offset of the movable subject from a center of the field of view; and (ii) a rate and direction of spatial movement of the movable subject within the field of view; and
adjusting a rotation rate of the rotation actuator in relation to a difference between the target rotation rate and the current rotation rate to maintain the moveable subject within the field of view.

16. The method of claim 14, further comprising:
monitoring a movement sensor positioned at one of the electronic device and the docking structure and configured to detect a movement of the electronic device related to rotation rate:
identifying a target rotation rate of the electronic device to maintain the movable subject within the field of view;
receives, from the movement sensor, a current rotation rate of the electronic device; and
adjusting a rotation rate of the rotation actuator in relation to a difference between the target rotation rate and the current rotation rate.

17. The method of claim 14, further comprising transferring electrical charge to a battery of the electronic device via a battery charging device of the support device that is one of electrically connected and electromagnetically coupled to the electronic device.
